(19) United States
(12) Patent Application Publication
(10) Pub. No.: US 2026/0311358 A1
(43) Pub. Date: Oct. 8, 2026

(54) SYSTEM AND METHOD FOR DETERMINING DIMENSIONS OF OBJECTS IN AN IMAGE

(71) Applicant: Infrrd Inc, San Jose, CA (US)

(72) Inventors: Srirama R. Nakshathri, Bengaluru (IN); Pratyusha Rasamsetty, Cupertino, CA (US); Deepak Kumar, Bengaluru (IN)

(73) Assignee: Infrrd Inc, San Jose, CA (US)

(21) Appl. No.: 19/171,386

(22) Filed: Apr. 7, 2025

(51) Int. Cl. G06T 7/60; G06T 7/73; G06V 10/25; G06V 30/19; G06V 30/414; G06V 30/422

(52) U.S. Cl. CPC G06T 7/60; G06T 7/73; G06V 10/25; G06V 30/1908; G06V 30/414; G06V 30/422; G06T 2207/20132; G06T 2207/30176

(57) ABSTRACT

A system for determining dimensions of one or more objects in an image via pixel quantification is disclosed. The system is configured to generate plurality of cropped images from a query image and scan them to detect a location of a scale. A scale bounding box encapsulating the scale is generated and a scale image from at least one of the cropped images within which the scale is detected is generated. Further, at least one label for each scale token is predicted, wherein each scale token is one among plurality of tokens detected from the scale image or the query image. A number of pixels based on the predicted labels is determined and a scale information from the scale based on the predicted labels is extracted. Finally, dimensions of one or more objects within the query image based on the determined number of pixels and the scale information is determined.

### BACKGROUND

### Field

The present invention relates generally to the analysis and digitization of engineering drawings and, more particularly, to an automated system and method for extracting scale information from engineering diagrams embedded in digital documents, such as PDFs, by integrating advanced image processing with optical character recognition (OCR) and heuristic techniques.

### Description of the Related Art

Engineering drawings are essential in various engineering disciplines—such as electrical, mechanical, and civil engineering—for conveying detailed design specifications and measurements. Traditionally, these drawings were produced and stored on paper, but the growing trend towards digital documentation has led to their widespread adoption in electronic formats like PDFs.

Despite the benefits of digital engineering drawings, accurately extracting scale information from these documents remains a significant challenge. Conventional methods often rely on manual interpretation or basic OCR techniques that primarily target textual content. Such approaches are frequently inadequate for identifying graphical scale markers or for correlating visual scale elements with their corresponding textual information.

Existing automated techniques for scale extraction are limited in that they tend to focus exclusively on either the visual or textual components of a drawing, without effectively integrating both. As a result, these methods may fail to accurately compute the conversion between digital pixel dimensions and real-world measurements—an essential factor for ensuring the fidelity of design data in digital engineering workflows.

In light of these shortcomings, there is a need for an improved system that combines robust object detection, specialized OCR, and heuristic analysis to reliably detect, extract, and interpret scale information from engineering drawings. The present invention addresses this need by providing a multi-step approach that enhances accuracy and efficiency in converting scale indicators from digital documents into real-world measurement data.

### SUMMARY

A system for determining dimensions of one or more objects in an image via pixel quantification is disclosed. The system comprising one or more processors may be configured to generate plurality of cropped images from a query image. The plurality of cropped images may then be scanned to detect a location of a scale in at least one of the cropped images. A scale bounding box encapsulating the scale may be generated. A scale image from at least one of the cropped images within which the scale is detected may be generated. At least one label for each scale token may be predicted, wherein each scale token may be one among plurality of tokens detected from the scale image or the query image. Further, a number of pixels based on the predicted labels may be determined. A scale information from the scale based on the predicted labels may be extracted. Finally, dimensions of one or more objects within the query image based on the determined number of pixels and the scale information may be determined.

A system for determining dimensions of one or more objects in an image via token recognition is disclosed. The system comprising one or more processors may be configured to generate plurality of cropped images from a query image. The plurality of cropped images may then be scanned to detect a location of a scale in at least one of the cropped images. A scale bounding box encapsulating the scale may be generated and further a scale image from at least one of the cropped images within which the scale is detected may be generated. At least one label for each scale token may be predicted, wherein each scale token may be one among plurality of tokens detected from the scale image or the query image. A scale information from the scale based on the predicted labels may be extracted. Finally, dimensions of one or more objects within the query image based on the scale information and at least one token among the plurality of tokens detected in the query image may be determined.

### BRIEF DESCRIPTION OF DRAWINGS

Embodiments are illustrated by way of example and not limitation in the figures of the accompanying drawings, in which like references indicate similar elements and in which:

FIG. 1A illustrates a system 100 enabling the determination of dimensions of one or more objects in an image, in accordance with an embodiment.

FIG. 1B illustrates a dimension determination module 110, in accordance with an embodiment.

FIG. 2 illustrates a flowchart 200 for a method enabling the detection of a scale and determination of dimensions of objects within Engineering Drawings (EDs), in accordance with an embodiment.

FIG. 3 illustrates a flowchart 300 for a method enabling the detection of the scale and determination of dimensions of objects within EDs, in accordance with another embodiment.

FIG. 4 is a block diagram illustrating a first data processing system 400, in accordance with an embodiment.

FIG. 5 is a block diagram illustrating a server 500, in accordance with an embodiment.

FIG. 6A illustrates a query image 106 with marking highlighting plurality of portions for cropping, in accordance with an embodiment.

FIG. 6B illustrates a scale bounding box 602 detected within one of the cropped portions of the query image 106, in accordance with an embodiment.

FIG. 7A illustrates an example of scale image with graphical and textual scale information for Engineering drawing, in accordance with an embodiment.

FIG. 7B illustrates an example of scale image with graphical and textual scale information for Engineering drawing, wherein scale information is different for both horizontal and vertical axis, in accordance with an embodiment.

FIG. 7C illustrates another example of scale image with graphical and textual scale information for Engineering drawing, in accordance with another embodiment.

FIG. 7D illustrates another example of scale images with textual scale information for Engineering drawing, wherein scale information is different for both horizontal and vertical axis, in accordance with an embodiment.

### DETAILED DESCRIPTION

Embodiments of the disclosed technology provide a system for automatically detecting scale and calculating the dimensions of objects such as pipes, furniture, walls, windows, and related components in Engineering Drawings (EDs). These diagrams serve as essential engineering documents that illustrate complex systems, where accurate measurement of dimensions is critical. The disclosed technology employs advanced image processing, optical character recognition (OCR), and heuristic methods to identify scale indicators and extract the necessary textual data, enabling the precise conversion of digital measurements into real-world dimensions. The disclosed system and method enhance the accuracy and efficiency of dimensional analysis in EDs, allowing end users to retrieve and interpret measurement data with greater reliability for improved engineering analysis and implementation.

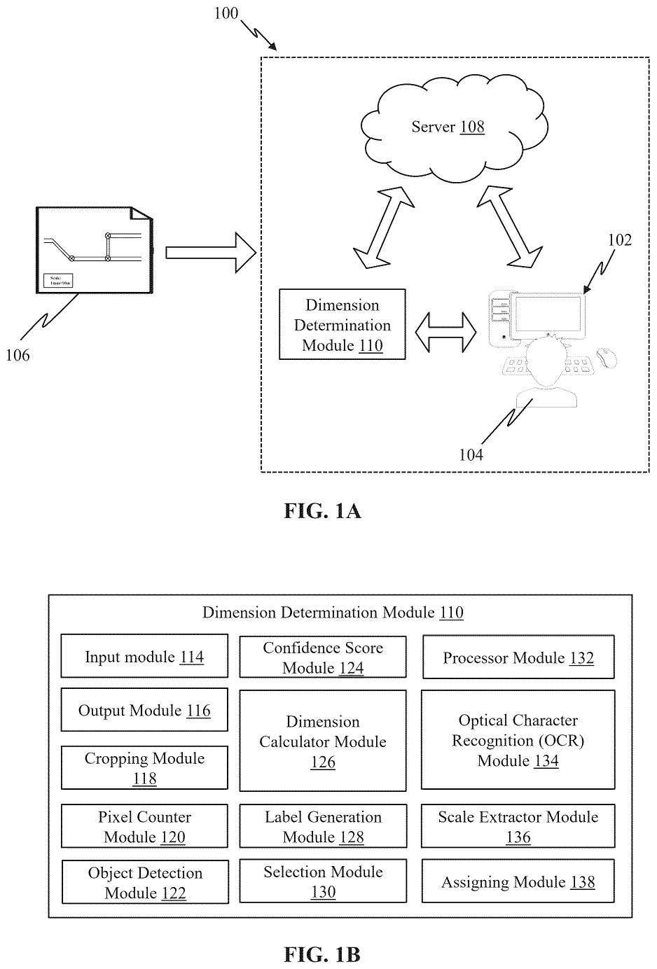

FIG. 1A illustrates a system 100 enabling the determination of dimensions of one or more objects in an image, in accordance with an embodiment. The system 100 may comprise of a data processing system 102 with an associated user 104, a server 108, and a dimension determination module 110. It may be noted that the dimension determination module 110 may be a part of the data processing system 102 or the server 108 in some embodiments. An example configuration of the data processing system 102 is discussed later (refer FIG. 4).

In an embodiment, the dimension determination module 110 may receive the query image 106 from the user 104, wherein the dimension determination module 110 upon processing the query image 106, may store detected scale of the query image 106, and the dimensions of objects in the query image 106 determined based on the scale of the query image 106 in the data processing system 102.

In an embodiment, the dimension determination module 110 may retrieve the query image 106 from the server 108, wherein the dimension determination module 110 upon processing the query image 106, may store detected scale of the query image 106, and the dimensions of objects in the query image 106 determined based on the scale of the query image 106 in the server 108. The user 104 may access the stored information from the server 108 via the data processing system 102.

In an embodiment, the query image 106 may be one image from the plurality of images present in the EDs.

In an alternate embodiment, plurality of pages present in the EDs may be converted into plurality of images, wherein query image 106 may be one among the plurality of images.

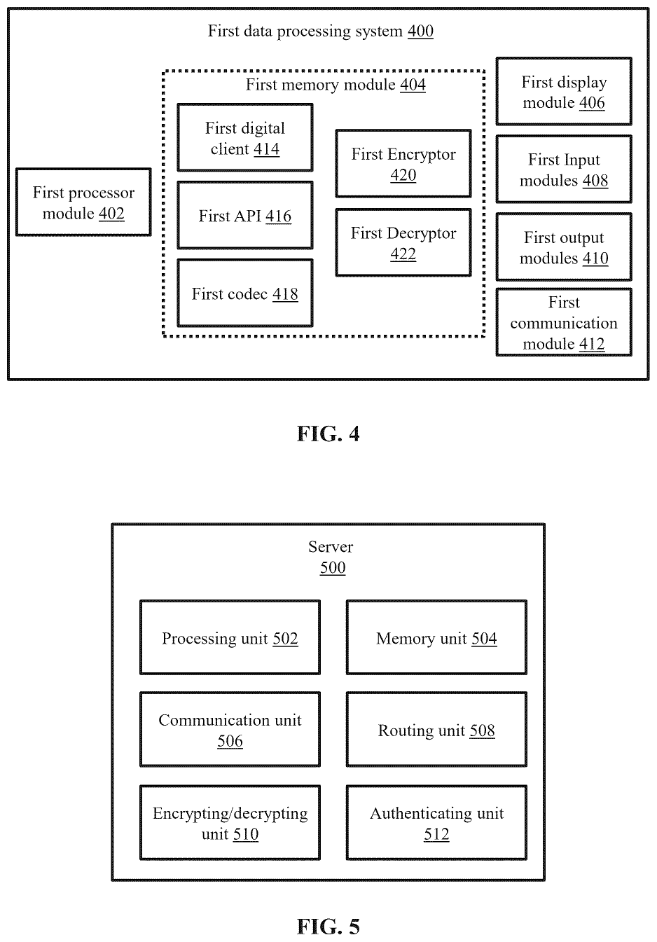

In an embodiment, the server 108 may be configured to enable communication among the data processing system 102, and the dimension determination module 110. An example configuration of the server 108 is discussed later (refer FIG. 5).

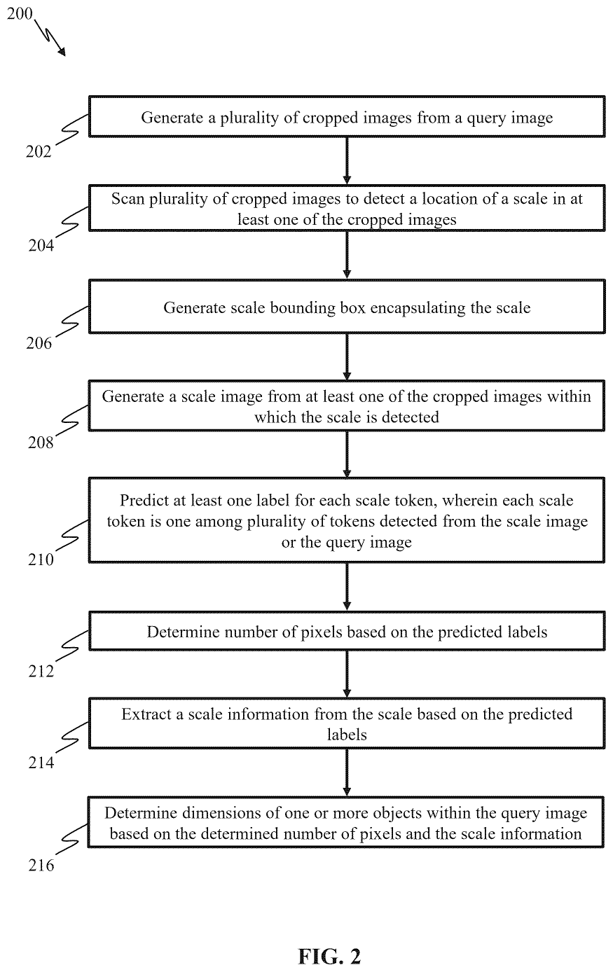

FIG. 1B illustrates the dimension determination module 110, in accordance with an embodiment. The dimension determination module 110 may comprise of an input module 114, an output module 116, a cropping module 118, a pixel counter module 120, an object detection module 122, a confidence score module 124, a dimension calculator module 126, a label generation module 128, a selection module 130, a processor module 132, an optical character recognition (OCR) module 134, a scale extractor module 136, and an assigning module 138. Functionality and association of each of the modules with each other is explained in greater detail in relation with the flowchart illustrated in FIG. 2 for easier understanding.

FIG. 2 illustrates a flowchart 200 for a method enabling the detection of scale and determination of dimensions of objects within EDs, in accordance with an embodiment.

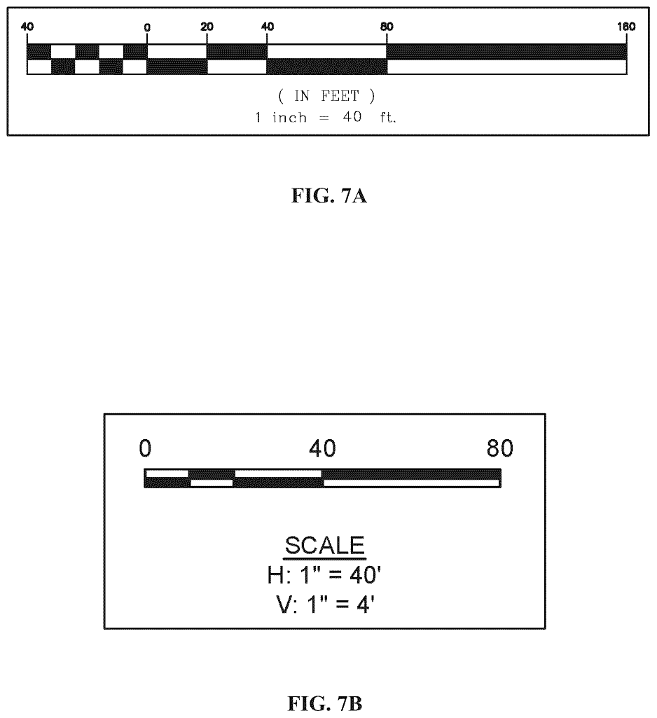

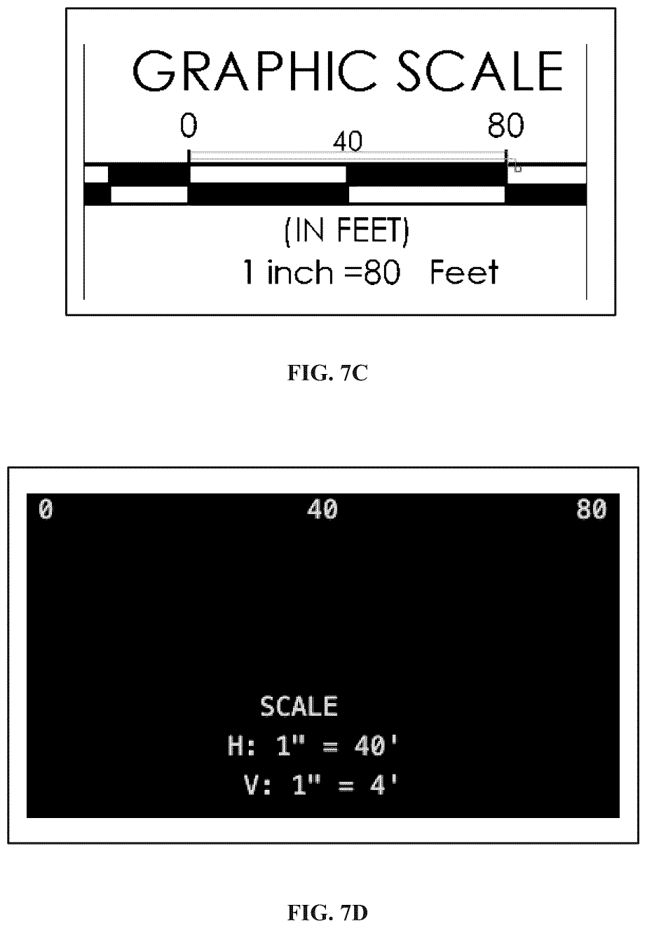

In an embodiment, the method discussed in the following paragraphs with respect to flowchart 200 is for Engineering drawings, wherein the scale information within the Engineering drawing(s) comprises of graphical representations and textual information (refer FIGS. 7A-7C).

In an embodiment, the dimension determination module 110 may receive the query image 106. The processor module 132 may be configured to instruct the plurality of modules present in the pipe mapping module 110.

At step 202, the input module 114 may receive the query image 106 and the cropping module 118 may generate a plurality of cropped images from the query image 106.

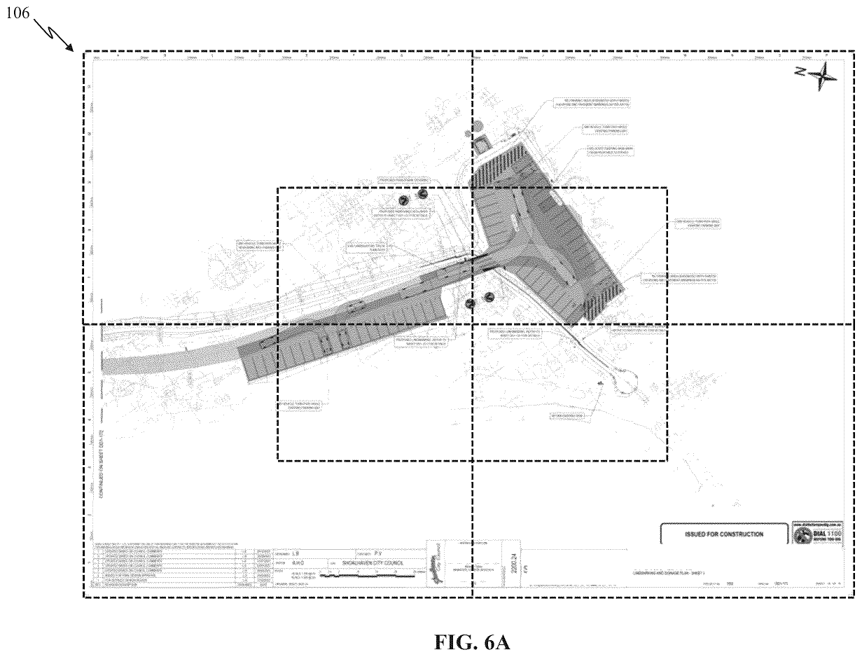

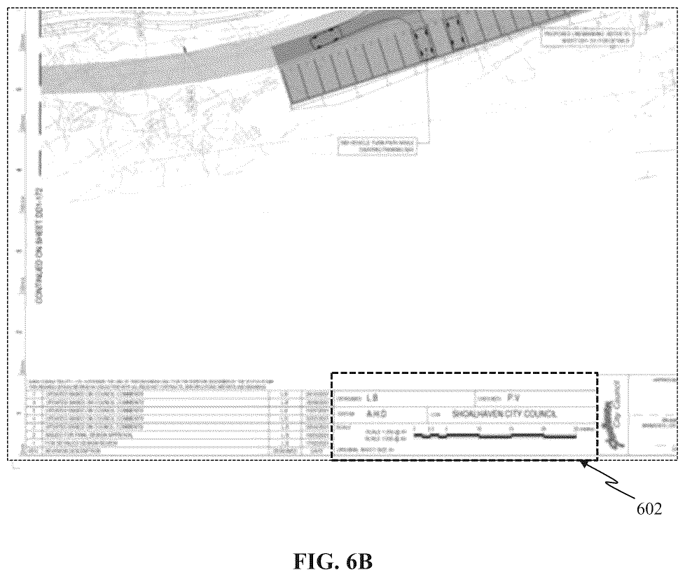

In an embodiment, the query image 106 may be cropped into five portions, namely, center portion, left-top portion, right-top portion, left-bottom portion, and right-bottom portion (refer FIG. 6).

In an embodiment, the cropping module 118 may be configured to take screenshots of the query image based on the portions described above and generate the plurality of cropped images.

At step 204, the object detection module 122 may be configured to detect a location of a scale in at least one of the cropped images.

In an embodiment, the object detection module 122 may be a YOLO model (or any model that employs computer vision) trained to determine the scale in the query image 106.

Object detection is a computer vision (CV) technique that encompasses various model-based approaches, including but not limited to YOLO, Detectron2, EfficientNet, Single Shot Detector (SSD), Faster R-CNN, Mask R-CNN, RetinaNet, CenterNet, Vision Transformer (ViT), and Swin Transformer. Object detection may be implemented using machine learning or deep learning methodologies. Additionally, object detection techniques may also include edge detection, keypoint detection, template matching, and other feature-based detection methods.

In an embodiment, the object detection module 122 may be configured to perform a pattern recognition to determine a scale pattern and neighboring elements in at least one of the cropped images. The object detection module 122 may be trained to recognize neighboring elements. Further, the object detection module 122 may be configured to determine the location of the scale based on the scale pattern and the neighboring elements.

In an embodiment, the scale pattern may be a bar featuring alternating black and white segments that visually denote specific dimensional intervals, such as one-inch increments. Numerical markings are provided on either the upper or lower side of the bar to clearly indicate these measurements.

At step 206, the object detection module 122 may be configured to generate a scale bounding box encapsulating the detected scale. (Refer to FIG. 6B, which illustrates an example of the generated scale bounding box, annotated with reference numeral 602)

In an embodiment, a portion of the scale may be detected in one of the cropped images and other portion of the scale may be detected in another of the cropped images. The object detection module 122 may create a first scale bounding box and a second scale bounding box for the respective portion of scales determined in each of the cropped images. Further, the object detection module 122 may be configured to merge the first scale bounding box and the second scale bounding box to generate the scale bounding box.

At step 208, based on the scale bounding box, the cropping module 118 may be configured to generate a scale image from the at least one of the cropped images within which the scale was detected.

In an embodiment, the confidence score module 124 may be configured to associate a confidence score with the scale bounding box, wherein the cropping module 118 may be configured to decide based on the confidence score to generate the appropriate scale image. (FIGS. 7A-7D illustrate examples of scale images. Refer to FIGS. 7A-7D for the following steps.)

At step 210, the label generation module 128 may be configured to predict at least one label for each scale token, wherein each scale token is one among plurality of tokens detected from the scale image or the query image.

Labeling is a natural language processing (NLP) technique that encompasses various methods, including sequence labeling, sentiment labeling, named entity recognition (NER), topic labeling, and other labeling techniques. Commonly utilized approaches include rule-based methods, machine learning models, and transformer-based techniques, such as SpaCy models, BERT, DistilBERT, RoBERTa, and other similar architectures. The label generation module 128 may be employ, but not limited to, any one of the forgoing methods.

In an embodiment, the OCR module 134 may be configured to detect plurality of first tokens and their corresponding bounding boxes in the scale image. Further, the OCR module 134 may be configured to detect plurality of second tokens within the scale bounding box in the query image 106. The selection module 130 may be configured to compare the plurality of first tokens and the plurality of second tokens and generate the scale tokens.

In an embodiment, the selection module 130 may be configured to select the second tokens from the query image 106 when corresponding at least two first tokens in the scale image are fragmented. As an example, a number “40” may be detected in the query image 106 as one token i.e., “40”, however in the scale image, it may be detected as two tokens i.e., “4” and “0”. The selection module 130 may be configured to select “40” from the query image 106 as one of the scale tokens.

In an embodiment, the selection module 130 may be configured to select the first token from the scale image when corresponding second token is absent in the query image 106. As an example, a number “0” may be detected in the scale image, however the same number may not be detected in the query image 106. The selection module 130 may be configured to select “0” from the scale image as one of the scale tokens.

In an embodiment, the selection module 130 may be configured to select the second token from the query image 106 when corresponding first token is same. As an example, a number “4” may be detected in both the scale image and the query image 106. The selection module 130 may be configured to select “4” from the query image 106 as one of the scale tokens.

In an embodiment, to predict at least one label for each scale token, the system may be configured to retrieve at least one label from plurality of labels based on the corresponding scale token.

In an embodiment, to predict at least one label for each scale token, the system may be configured to retrieve at least one label from plurality of labels based on the corresponding scale token, wherein the confidence score module 124 may be configured to associate a label confidence score with each of the predicted labels.

In an embodiment, the assigning module 138 may be configured to assign corresponding predicted label to a start position and an end position associated with each scale token.

At step 212, the pixel counter module 120 may be configured to determine number of pixels based on the predicted labels.

In an embodiment, the pixel counter module 120 may be configured to establish a relationship between the scale tokens and the scale pattern based on the predicted labels. Further, the pixel counter module 120 may be configured to determine the number of pixels within at least a portion of the scale portion.

In an embodiment, the pixel counter module 120 is configured to measure the number of pixels along the scale pattern between designated numerical scale tokens (e.g., “0” and “40”), where said scale tokens represent specific dimensional intervals such as one inch.

At step 214, the scale extractor module 136 may be configured to extract a scale information from the scale based on the predicted labels. For example, using the predicted labels corresponding to “1”, “inch”, “=”, “40”, and “feet”, the module may extract the scale information as “1 inch=40 feet.”

In an embodiment, the scale extractor module 136 may be configured to determine the scale information associated with a horizontal scale. Further, the scale extractor module 136 may be configured to determine the scale information associated with a vertical scale, wherein the horizontal scale and the vertical scale may be determined based on the scale tokens and the corresponding labels.

In another embodiment, the scale bounding box may comprise of multiple text tokens arranged in various patterns, wherein such patterns may be analyzed and addressed by employing a heuristic or rule-based approach. With the heuristic approach, the number of numerical lines within the scale bounding box may be identified to determine the scaling orientation. If a single numerical line is detected, it may be assumed to represent both horizontal and vertical scales. Conversely, if two numerical lines are detected, they may be interpreted as distinct horizontal and vertical scales. The presence of horizontal and vertical scales may be determined by recognizing specific text tokens. Additionally, the scale ratio denominator within the scale may be identified to compute the scale information based on pixel count determined.

At step 216, the dimension calculator module 126 may be configured to determine dimensions of one or more objects within the query image based on the determined number of pixels and the scale information. For example, if a user queries the dimension of an object, the system may be configured to calculate the number of pixels that correspond to that object and use the scale information (e.g., “1 inch=40 feet”) and determined number of pixels based on the scale pattern to convert the pixel measurement into a real-world dimension.

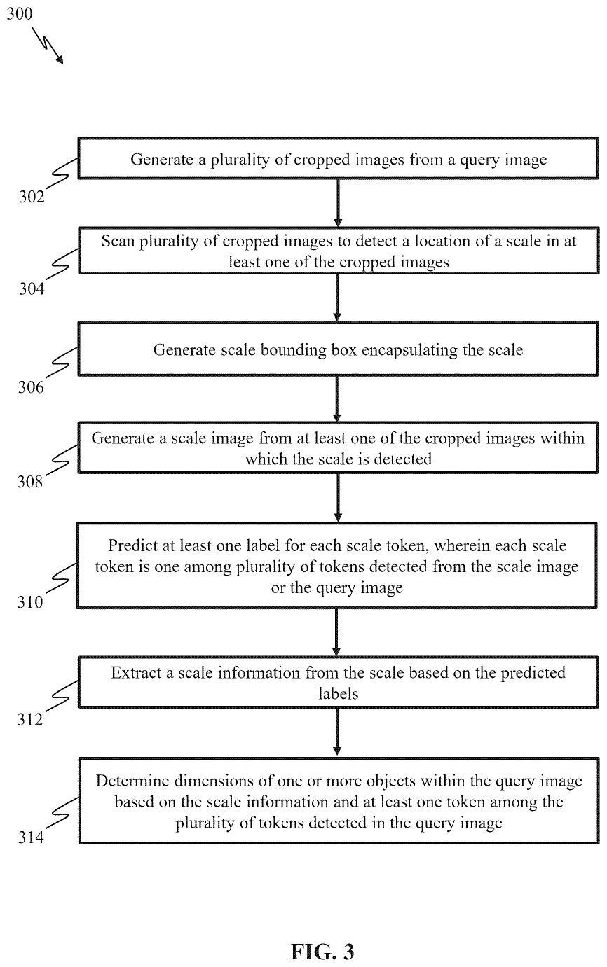

Moving on, FIG. 3 illustrates a flowchart 300 for a method enabling the detection of scale and determination of dimensions of objects within EDs, in accordance with another embodiment.

In an embodiment, the method discussed in the following paragraphs with respect to flowchart 300 is for Engineering drawings, wherein the scale information within the Engineering drawing(s) comprises of only textual information (refer FIG. 7D).

The dimension determination module 110 may receive the query image 106. The processor module 132 may be configured to instruct the plurality of modules present in the pipe mapping module 110.

At step 302, the input module 114 may receive the query image 106 and the cropping module 118 may generate a plurality of cropped images from the query image 106.

In an embodiment, the query image 106 may be cropped into five portions, namely, center portion, left-top portion, right-top portion, left-bottom portion, and right-bottom portion.

In an embodiment, the cropping module 118 may be configured to take screenshots of the query image based on the portions described above and generate the plurality of cropped images.

At step 304, the object detection module 122 may be configured to detect a location of a scale in at least one of the cropped images.

As discussed in the foregoing, the object detection module 122 may be, but not limited to, a YOLO model. The objection detection module 122 could be any model that employs computer vision. This computer vision implementation is discussed in the foregoing and therefore not repeated for the sake of brevity.

In an embodiment, the object detection module 122 may be configured to perform a keyword recognition to determine a predetermined keyword and neighboring elements in at least one of the cropped images. The object detection module 122 may be trained to recognize neighboring elements. Further, the object detection module 122 may be configured to determine the location of the scale based on the predetermined keyword and the neighboring elements.

At step 306, the object detection module 122 may be configured to generate a scale bounding box encapsulating the detected scale.

In an embodiment, a portion of the scale may be detected in one of the cropped images and other portion of the scale may be detected in another of the cropped images. The object detection module 122 may create a first scale bounding box and a second scale bounding box for the respective portion of scales determined in each of the cropped images. Further, the object detection module 122 may be configured to merge the first scale bounding box and the second scale bounding box to generate the scale bounding box.

At step 308, based on the scale bounding box, the cropping module 118 may be configured to generate a scale image from the at least one of the cropped images within which the scale is detected.

In an embodiment, the confidence score module 124 may be configured to associate a confidence score with the scale bounding box, wherein the cropping module 118 may be configured to decide based on the confidence score to generate the appropriate scale image.

At step 310, the label generation module 128 may be configured to predict at least one label for each scale token, wherein each scale token is one among plurality of tokens detected from the scale image or the query image.

The different approaches within labeling that may be employed by the label generation module 128 are discussed in the foregoing and therefore not repeated for the sake of brevity.

In an embodiment, the OCR module 134 may be configured to detect plurality of first tokens and their corresponding bounding boxes in the scale image. Further, the OCR module 134 may be configured to detect plurality of second tokens within the scale bounding box in the query image 106. The selection module 130 may be configured to compare the plurality of first tokens and the plurality of second tokens and generate the scale tokens.

In an embodiment, the selection module 130 may be configured to select the second tokens from the query image when corresponding at least two first tokens in the scale image are fragmented. As an example, a number “40” may be detected in the query image as one token i.e., “40”, however in the scale image, it may be detected as two tokens i.e., “4” and “0”. The selection module 136 may be configured to select “40” from the query image as one of the scale tokens.

In an embodiment, the selection module 130 may be configured to select the first token from the scale image when corresponding second token is absent in the query image. As an example, a number “0” may be detected in the scale image, however the same number may not be detected in the query image. The selection module 130 may be configured to select “0” from the scale image as one of the scale tokens.

In an embodiment, the selection module 130 may be configured to select the second token from the query image when corresponding first token is same. As an example, a number “4” may be detected in both the scale image and the query image 106. The selection module 130 may be configured to select “4” from the query image 106 as one of the scale tokens.

In an embodiment, to predict at least one label for each scale token, the system may be configured to retrieve at least one label from plurality of labels based on the corresponding scale token, wherein the confidence score module 124 may be configured to associate a label confidence score with each of the predicted labels.

In an embodiment, the assigning module 138 may be configured to assign corresponding predicted label to a start position and an end position associated with each scale token.

At step 312, the scale extractor module 136 may be configured to extract a scale information from the scale based on the predicted labels. For example, using the predicted labels corresponding to “1”, “inch”, “=”, “40”, and “feet”, the module 136 may extract the scale information as “1 inch=40 feet”. As another example, using the predicted labels corresponding to “1”, “:”, and “40”, the module 136 may extract the scale information as “1:40”.

In an embodiment, the scale extractor module 140 may be configured to determine the scale information associated with a horizontal scale. Further, the scale extractor module 136 may be configured to determine the scale information associated with a vertical scale, wherein the horizontal scale and the vertical scale may be determined based on the scale tokens and the corresponding labels.

In another embodiment, a heuristic approach may be employed. The heuristic approach is already discussed in the foregoing and therefore not repeated for the sake of brevity.

At step 314, the dimension calculator module 126 may be configured to determine dimensions of one or more objects within the query image based on the determined number of pixels and the scale information. For example, if a user queries the dimension of an object, the system may be configured to retrieve the dimensions that correspond to that object based on OCR performed on the query image 106 and use the scale information (e.g., “1:40”) to determine a real-world dimension of the queried object.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The methods described above may be implemented by a data processing system that performs the steps through executing instructions stored on a non-transitory computer-readable medium.

The example embodiments described herein may be implemented in an operating environment comprising software installed on a computer, in hardware, or in a combination of software and hardware.

Moving on, we now explain an example configuration of the data processing system associated with the end user. FIG. 4 is a block diagram illustrating a first data processing system 400, in accordance with an embodiment. The first data processing system 400 may comprise a first processor module 402, a first memory module 404, a first display module 406, first input modules 408, first output modules 410 and a first communication module 412.

The first processor module 402 may be implemented in the form of one or more processors and may be implemented as appropriate in hardware, computer-executable instructions, firmware, or combinations thereof. Computer-executable instruction or firmware implementations of the first processor module 402 may include computer-executable or machine-executable instructions written in any suitable programming language to perform the various functions described.

The first memory module 404 may include a permanent memory such as hard disk drive, may be configured to store data, and executable program instructions that are implemented by the processor module. The first memory module 404 may be implemented in the form of a primary and a secondary memory. The first memory module 404 may store additional data and program instructions that are loadable and executable on the first processor module 402, as well as data generated during the execution of these programs. Further, the first memory module 404 may be volatile memory, such as random-access memory and/or a disk drive, or non-volatile memory. The first memory module 404 may comprise of removable memory such as a Compact Flash card, Memory Stick, Smart Media, Multimedia Card, Secure Digital memory, or any other memory storage that exists currently or may exist in the future.

In an embodiment, the first memory module 404 may further comprise a first digital client 414, a first Application Programming Interface (API) 416, a first codec 418, a first encryptor 420 and a first decryptor 422. The first digital client 414 may be a web browser or a software application. The first codec 418 may include computer-executable or machine-executable instructions written in any suitable programming language to perform compress outgoing data and decompress incoming data. The first encryptor 420 may encrypt the data being sent and the first decryptor 422 may decrypt the incoming data.

The first display module 406 may display an image, a video, or data to a user. For example, the first display module 406 may include a panel, and the panel may be an LCD, LED or an AM-OLED.

The first input modules 408 may provide an interface for input devices such as keypad, touch screen, mouse and stylus among other input devices. In an embodiment, the first input modules 408 includes a scanner, a barcode reader, a camera and/or a microphone.

The first output modules 410 may provide an interface for output devices such as display screen, speakers, printer and haptic feedback devices, among other output devices.

The first communication module 412 may be used by the first data processing system 400 to communicate with the server 500. The first communication module 412, as an example, may be a GPRS module, or other modules that enable wireless communication.

Further, we now explain an example configuration of the server 500 enabling the data processing systems to establish communication. FIG. 5 is a block diagram illustrating a server 500, in accordance with an embodiment. The server 500 may comprise a processing unit 502, a memory unit 504, a communication unit 506, a routing unit 508, an encrypting/decrypting unit 510 and an authenticating unit 512.

The processing unit 502 may be implemented in the form of one or more processors and may be implemented as appropriate in hardware, computer-executable instructions, firmware, or combinations thereof. Computer-executable instruction or firmware implementations of the processing unit 502 may include computer-executable or machine-executable instructions written in any suitable programming language to perform the various functions described.

The memory unit 504 may include a permanent memory such as hard disk drive, may be configured to store data, and executable program instructions that are implemented by the processor module.

The communication unit 506 may be used by the server 500 to communicate with the first data processing system 400. The communication unit 506, as an example, may be a GPRS module, or other modules that enable wireless communication.

The routing unit 508 may enable identification of data processing systems to which the data must be transmitted.

The encrypting/decrypting unit 510 may encrypt the incoming data from the first data processing system 400 and decrypt the outgoing data from the server 500.

The authenticating unit 512 may authenticate the first data processing system 400 before establishing a connection.

The foregoing description refers to the various steps being carried out by a data processing system. Such a data processing system may be a stand-alone data processing system or a network of data processing system(s) and server.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

The detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

What is claimed is:

1. A system for determining dimensions of one or more objects in an image via pixel quantification, the system comprising one or more processors is configured to:
generate, by a cropping module, plurality of cropped images from a query image;
scan plurality of cropped images, by an object detection module, to detect a location of a scale in at least one of the cropped images;
generate, by the object detection module, a scale bounding box encapsulating the scale;
generate, by the cropping module, a scale image from at least one of the cropped images within which the scale is detected;
predict, by a label generation module, at least one label for each scale token, wherein each scale token is one among plurality of tokens detected from the scale image or the query image;
determine, by a pixel counter module, number of pixels based on the predicted labels;
extract, by a scale extractor module, a scale information from the scale based on the predicted labels; and
determine, by a dimension calculator module, dimensions of one or more objects within the query image based on the determined number of pixels and the scale information.

2. The system according to claim 1, wherein to detect the location of the scale in at least one of the cropped images the system is configured to:
perform, by the object detection module, a pattern recognition to determine a scale pattern and neighboring elements in at least one of the cropped images; and
determine, by the object detection module, the location of the scale based on the scale pattern and the neighboring elements.

3. The system according to claim 2, wherein the system is configured to merge a first scale bounding box and a second scale bounding box to generate the scale bounding box, wherein:
the first scale bounding box is associated with a portion of the scale detected in one of the cropped images; and
the second scale bounding box is associated with the portion of the scale detected in another of the cropped images.

4. The system according to claim 2, wherein to determine the number of pixels based on the predicted labels the system is configured to:
establish, by the pixel counter module, a relationship between the scale tokens and the scale pattern based on the predicted labels; and
determine, by the pixel counter module, the number of pixels within at least a portion of the scale pattern.

5. The system according to claim 1, wherein to generate the scale tokens, the system is configured to:
perform, by an Optical Character Recognition (OCR) module, OCR to detect plurality of first tokens and their corresponding bounding boxes in the scale image;
perform, by the OCR module, OCR to detect plurality of second tokens within the scale bounding box in the query image;
compare, by a selection module, the plurality of first tokens identified in the scale image and the plurality of second tokens identified in the query image; and
generate, by the selection module, scale tokens based on the plurality of first tokens and the plurality of second tokens.

6. The system according to claim 5, wherein the selection module is configured to:
select the second token from the query image when corresponding at least two first tokens in the scale image are fragmented;
select the first token from the scale image when corresponding second token is absent in the query image; and
select the second token from the query image when corresponding first token is same.

7. The system according to claim 1, wherein to predict at least one label for each scale token, the system is configured to retrieve at least one label from plurality of labels based on the corresponding scale token.

8. The system according to claim 7, wherein an assigning module is configured to assign the corresponding predicted label to a start position and an end position associated with each scale token.

9. The system according to claim 1, wherein to extract the scale information from the scale based on the predicted labels, the system is configured to:
determine the scale information associated with a horizontal scale; and
determine the scale information associated with a vertical scale, wherein the horizontal scale and the vertical scale are determined based on the scale tokens and the corresponding labels.

10. A system for determining dimensions of one or more objects in an image via token recognition, the system comprising one or more processors is configured to:
generate, by a cropping module, plurality of cropped images from a query image;
scan plurality of cropped images, by an object detection module, to detect a location of a scale in at least one of the cropped images;
generate, by the object detection module, a scale bounding box encapsulating the scale;
generate, by the cropping module, a scale image from at least one of the cropped images within which the scale is detected;
predict, by a label generation module, at least one label for each scale token, wherein each scale token is one among plurality of tokens detected from the scale image or the query image;
extract, by a scale extractor module, a scale information from the scale based on the predicted labels; and
determine, by a dimension calculator module, dimensions of one or more objects within the query image based on the scale information and at least one token among the plurality of tokens detected in the query image.

11. The system according to claim 10, wherein the system is configured to merge a first scale bounding box and a second scale bounding box to generate the scale bounding box, wherein:
the first scale bounding box is associated with a portion of the scale detected in one of the cropped images; and
the second scale bounding box is associated with the portion of the scale detected in another of the cropped images.

12. The system according to claim 10, wherein to generate the scale tokens, the system is configured to:
perform, by an Optical Character Recognition (OCR) module, OCR to detect plurality of first tokens and their corresponding bounding boxes in the scale image;
perform, by the OCR module, OCR to detect plurality of second tokens within the scale bounding box and their corresponding bounding boxes in the query image;
compare, by a selection module, the plurality of first tokens identified in the scale image and the plurality of second tokens identified in the query image; and
generate, by the selection module, scale tokens based on the plurality of first tokens and the plurality of second tokens.

13. The system according to claim 12, wherein the selection module is configured to:
select the second token from the query image when corresponding at least two first tokens in the scale image are fragmented;
select the first token from the scale image when corresponding second token is absent in the query image; and
select the second token from the query image when corresponding first token is same.

14. The system according to claim 10, wherein to predict at least one label for each scale token, the system is configured to retrieve at least one label from plurality of labels based on the corresponding scale token.

15. The system according to claim 14, wherein an assigning module is configured to assign the corresponding predicted label to a start position and an end position associated with each scale token.

16. A method for determining dimensions of one or more objects in an image via pixel quantification by a system comprising one or more processors, the method comprising the steps of:
generating, by a cropping module, plurality of cropped images from a query image;
scanning plurality of cropped images, by an object detection module, to detect a location of a scale in at least one of the cropped images;
generating, by the object detection module, a scale bounding box encapsulating the scale;
generating, by the cropping module, a scale image from at least one of the cropped images within which the scale is detected;
predicting, by a label generation module, at least one label for each scale token, wherein each scale token is one among plurality of tokens detected from the scale image or the query image;
determining, by a pixel counter module, number of pixels based on the predicted labels;
extracting, by a scale extractor module, a scale information from the scale based on the predicted labels; and
determining, by a dimension calculator module, dimensions of one or more objects within the query image based on the determined number of pixels and the scale information.

17. A method for determining dimensions of one or more objects in an image via token recognition by a system comprising one or more processors, the method comprising the steps of:
generating, by a cropping module, plurality of cropped images from a query image;
scanning plurality of cropped images, by an object detection module, to detect a location of a scale in at least one of the cropped images;
generating, by the object detection module, a scale bounding box encapsulating the scale;
generating, by the cropping module, a scale image from at least one of the cropped images within which the scale is detected;
predicting, by a label generation module, at least one label for each scale token, wherein each scale token is one among plurality of tokens detected from the scale image or the query image;
extracting, by a scale extractor module, a scale information from the scale based on the predicted labels; and
determining, by a dimension calculator module, dimensions of one or more objects within the query image based on the scale information and at least one token among the plurality of tokens detected in the query image.
